(19) United States
(12) Patent Application Publication
(10) Pub. No.: US 2010/0281525 A1
(43) Pub. Date: Nov. 4, 2010

(54) COMMUNICATION SYSTEM, COMMUNICATION METHOD, TERMINAL AND MANAGEMENT DEVICE

(75) Inventor: Takafumi Nakajima, Mitaka-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/811,824

(22) PCT Filed: Mar. 4, 2009
(86) PCT No.: PCT/JP2009/054598

§ 371 Date: Jul. 6, 2010

(30) Foreign Application Priority Data
Mar. 12, 2008 (JP) 2008-063160

(51) Int. Cl. H04L 12/28; G06F 21/20

(52) U.S. Cl. 726/5; 370/254

(57) ABSTRACT

A communication system includes a plurality of terminals and a management device that manages a plurality of networks. A first terminal, which is connected to a first network to which the management device is also connected, transmits a connection request for connecting to a second network to the management device. Upon receiving the connection request, the management device determines a predetermined topology from among a plurality of topologies that can be formed when the first terminal connects to the second network. The first terminal receives network configuration information indicating the predetermined topology from the management device. The first terminal transmits the network configuration information to a plurality of terminals participating in the second network. The second network is recreated accordingly.

### TECHNICAL FIELD

The present invention relates to a communication system that creates a plurality of networks.

### BACKGROUND ART

In recent years, wireless LAN (Local Area Networks) systems compliant with IEEE 802.11 standards have become widely used. Communication modes in such wireless LANS include an infrastructure mode, an ad hoc mode, and a WDS (Wireless Distribution system) mode. The infrastructure mode is a communication mode in which terminals (hereinafter, called STAs) perform indirect communication via an access point (hereinafter, called an AP) that is a wireless base station. The ad hoc mode is a communication mode in which STAs perform direct communication with each other, without going through an AP. The WDS mode is a communication mode used in communication between APs.

In general, whether a wireless communication device is to operate as an STA or operate as an AP is determined at the time of manufacturing. However, a wireless communication device that can operate as both an STA and an AP has been proposed (Japanese Patent Laid-Open No. 08-298687). In other words, such a wireless communication device can switch between an STA mode and an AP mode. Note that a terminal that is compatible with both the STA mode and the AP mode is called a “dual mode terminal” for convenience.

Japanese Patent Laid-Open No. 08-298687 proposes a method of autonomously determining a wireless communication device to be an access point in a case where there is more than one wireless communication device that is dual mode compatible.

### DISCLOSURE OF INVENTION

For example, consider a case in which a first network and a second network have been created in a communication system, and a wireless communication device newly participates in the second network. In this case, there is a danger of communication bandwidth in the second network being wasted, depending on the network configuration of the second network.

FIG. 14 shows an example of a network in a wireless communication system. In this case, a wireless communication device 101 has newly participated in the second network. In the second network, wireless communication devices 102 and 104 that are dual mode terminals have been communicating in advance. Also, the wireless communication device 102 is operating in the AP mode, and the wireless communication device 104 is operating in the STA mode. The wireless communication device 101 desires to perform communication with the wireless communication device 104.

According to conventional technology, the wireless communication device 101 performs communication with the wireless communication device 104 via the wireless communication device 102 that is operating in the AP mode. For this reason, communication bandwidth is wasted. In this case, two 10 Mbps wireless links have been established between the wireless communication device 102 and wireless communication device 104. Also, a 5 Mbps wireless link has been established between the wireless communication device 102 and wireless communication device 101. Therefore, the total communication bandwidth being used is 25 Mbps.

FIG. 15 shows another example of a network in a wireless communication system. FIG. 15 differs from FIG. 14 in that the wireless communication device 104 has switched to an access point. In other words, the network topology has changed. In this case, since the total communication bandwidth is 15 Mbps, the communication bandwidth has been improved 10 Mbps over the case shown in FIG. 14. In other words, communication bandwidth was being needlessly consumed in the topology shown in FIG. 14. In this way, there is a possibility of the communication bandwidth being improved by changing the topology. However, if the execution of the processing for changing the topology is distributed among the wireless communication devices, there is a danger of an increase in the complexity of the network.

In view of this, an object of the present invention is to solve at least either the above problem or another problem. For example, an object of the present invention is to, when a terminal has newly participated in the second network, recreate the second network so that communication bandwidth is not wasted. Note that solutions to other problems will be understood through the description as a whole.

A communication system of the present invention includes a plurality of terminals and a management device that manages a plurality of networks. The plurality of terminals includes a first terminal that is connected to a first network to which the management device is connected, and the first terminal includes a first transmission means, a first reception means, a notification means, and a recreation means. The first transmission means is for transmitting, to the management device, a connection request for connecting to a second network that is different from the first network. The first reception means is for receiving, from the management device, network configuration information indicating a predetermined topology from among a plurality of topologies that can be formed when the first terminal connects to the second network. The notification means is for notifying the received network configuration information to a plurality of terminals participating in the second network. The recreation means is for recreating the second network along with the plurality of terminals participating in the second network, in accordance with the network configuration information. The management device includes a second reception means and a second transmission means. The second reception means is for receiving the connection request from the first terminal. The second transmission means is for transmitting, to the first terminal, the network configuration information indicating the predetermined topology from among the plurality of topologies that can be formed when the first terminal connects to the second network.

A terminal of the present invention is used in a communication system including a management device that manages a plurality of networks. The terminal includes a first transmission means, a reception means, a notification means, and a recreation means. The first transmission means is for transmitting, to the management device, a connection request for connecting to a second network that is different from a first network to which the management device is connected. The reception means is for receiving, from the management device, network configuration information indicating a predetermined topology from among a plurality of topologies that can be formed when the terminal connects to the second network. The notification means is for notifying the received network configuration information to a plurality of terminals participating in the second network. The recreation means is for recreating the second network along with the plurality of terminals participating in the second network, in accordance with the network configuration information.

A management device of the present invention manages a plurality of networks. The management device includes a reception means and a transmission means. The reception means is for receiving a connection request from a first terminal that is connected to a first network to which the management device is also connected, the connection request being for connecting to a second network that is different from the first network. The transmission means is for transmitting, to the first terminal, network configuration information indicating a predetermined topology from among a plurality of topologies that can be formed when the first terminal connects to the second network.

Further features of the present invention will become apparent from the following description of exemplary embodiments with reference to the attached drawings.

### BRIEF DESCRIPTION OF DRAWINGS

FIG. 1 is a diagram showing an example of a communication system according to an embodiment.

FIG. 2 is a diagram showing an exemplary internal configuration of a wireless communication device 101.

FIG. 3 is a diagram showing an exemplary internal configuration of wireless communication devices 102 and 104.

FIG. 4 is a diagram showing an exemplary internal configuration of a management device 109.

FIG. 5 is a diagram showing an example of network configuration information according to an embodiment.

FIG. 6 is an exemplary sequence diagram showing a sequence in a communication method according to an embodiment.

FIG. 7 is a diagram showing an example of newly generated network configuration information according to an embodiment.

FIG. 8 is a flowchart showing an example of communication processing performed by the wireless communication device 101 according to an embodiment.

FIG. 9 is a flowchart showing an example of communication processing performed by a management device according to an embodiment.

FIG. 10 is a flowchart showing an example of new second network configuration information creation processing (S903) according to an embodiment.

FIG. 11 is an exemplary flowchart showing communication processing performed by the wireless communication device 102 and wireless communication device 104 according to an embodiment.

FIG. 12 is a diagram showing a list of encryption systems with which wireless communication devices according to an embodiment are compatible.

FIG. 13 is a flowchart showing an example of processing for newly creating network configuration information based on an encryption system (S903).

FIG. 14 is a diagram showing an example of a network in a wireless communication system.

FIG. 15 is a diagram showing another example of a network in a wireless communication system.

### BEST MODE FOR CARRYING OUT THE INVENTION

The following describes embodiments of the present invention. The individual embodiments described below will be useful for understanding various concepts of the present invention, such as broad concepts, intermediate concepts, and narrow concepts. Also, the technical scope of the present invention should be determined by the scope of the claims, and should not be limited by the individual embodiments below.

### Embodiment 1

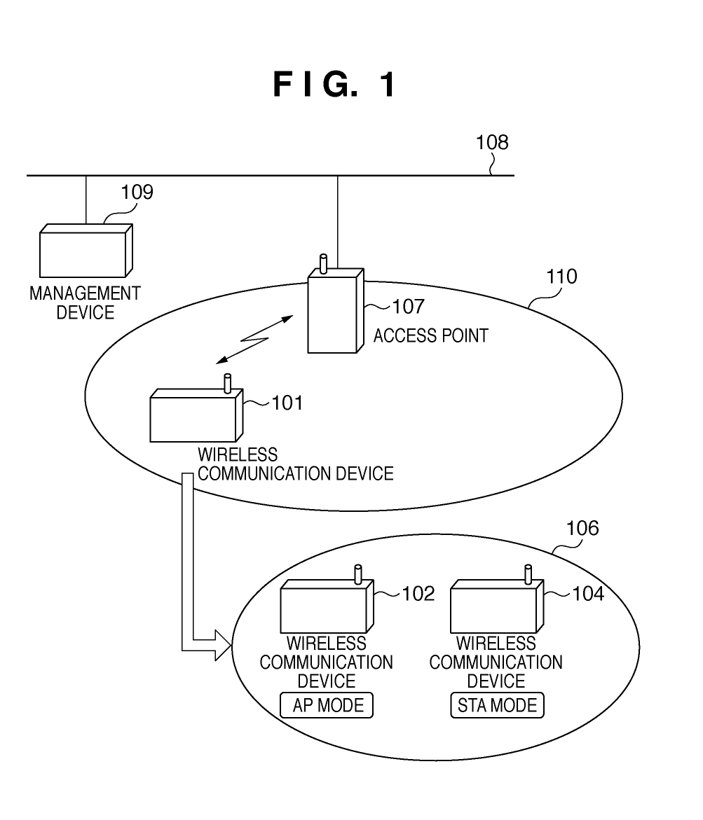

FIG. 1 is a diagram showing an example of a communication system according to the present embodiment. FIG. 1 shows a plurality of networks, including a first network 110 and a second network 106. Of course, three or more networks may exist.

The first network 110 includes a wireless communication device 101 and an access point 107. The second network 106 includes a wireless communication device 102 and a wireless communication device 104. These wireless LANs have been created in compliance with, for example, IEEE 802.11 standards. Note that a wired LAN 108 includes a management device 109 and the access point 107.

The wireless communication devices 101, 102 and 103 have a wireless LAN communication function. In particular, the wireless communication device 102 and wireless communication device 104 are dual mode terminals that are compatible with an AP mode and an STA mode. A dual mode terminal operates in an operation mode that is either the AP mode or the STA mode.

The access point 107 has a wired LAN communication function in addition to a wireless LAN communication function. On the other hand, the management device 109 of this description lacks a wireless LAN communication function, and only has a wired LAN communication function. Of course, the management device 109 may also include a wireless LAN communication function.

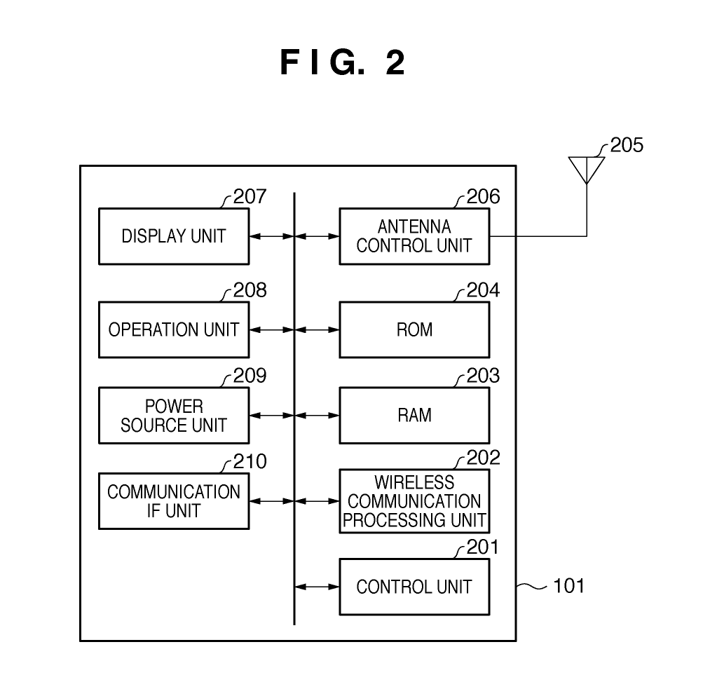

FIG. 2 is a diagram showing an exemplary internal configuration of the wireless communication device 101. A control unit 201 performs overall control of units included in the wireless communication device 101. A wireless communication processing unit 202 performs wireless LAN communication control. A RAM 203 is a volatile memory. A ROM 204 is a non-volatile memory storing control instructions (a computer program). An antenna 205 receives electromagnetic waves (a wireless signal) transmitted by other wireless communication devices. An antenna control unit 206 is a so-called RF unit that, for example, restores information by demodulating and decoding a wireless signal, and generates a transmission signal by encoding and modulating data targeted for transmission. A display unit 207 is a liquid crystal display or the like. An operation unit 208 is a switch, button, or the like. A power source unit 209 supplies power to units in the wireless communication device 101. A communication IF unit 210 is a communication circuit such as a USB communication circuit or an IEEE 1394 communication circuit.

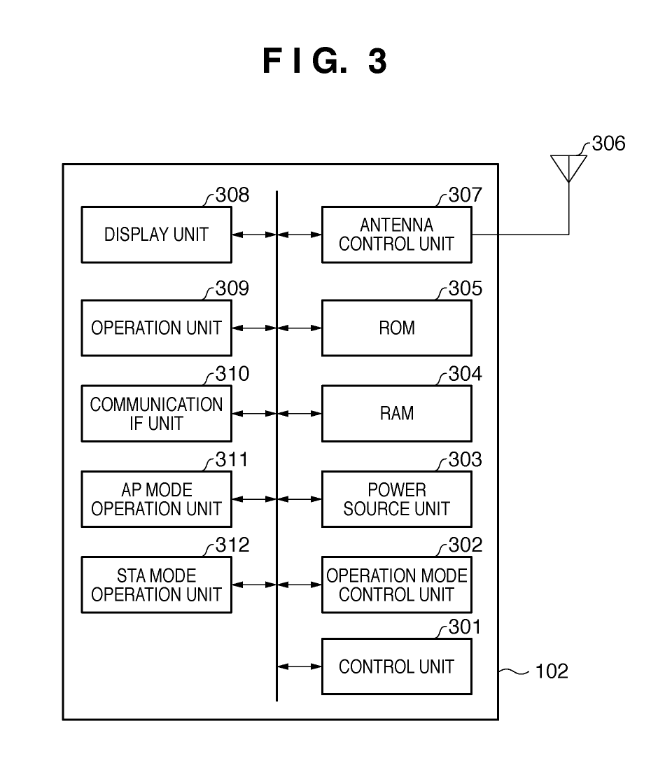

FIG. 3 is a diagram showing an exemplary internal configuration of the wireless communication devices 102 and 104. A control unit 301 performs overall control of units included in the wireless communication device. An operation mode control unit 302 performs wireless LAN communication control such as switching between wireless LAN operation modes. A power source unit 303 supplies power to units in the wireless communication device. A RAM 304 is a volatile memory. A ROM 305 is a non-volatile memory storing control instructions (a computer program). An antenna 306 receives electromagnetic waves (a wireless signal) transmitted by other wireless communication devices. An antenna control unit 307 is a so-called RF unit that, for example, restores information by demodulating and decoding a wireless signal, and generates a transmission signal by encoding and modulating data targeted for transmission. A display unit 308 is a liquid crystal display or the like. An operation unit 309 is a switch, button, or the like. A communication IF unit 310 is a communication circuit such as a USB communication circuit or an IEEE 1394 communication circuit. An AP mode operation unit 311 is a communication processing unit for causing the wireless communication device to operate in the AP mode. An STA mode operation unit 312 is a communication processing unit for causing the wireless communication device to operate in the STA mode. Note that the internal configuration of the access point 107 may be the same as or different from the internal configurations of the wireless communication devices 101 and 102.

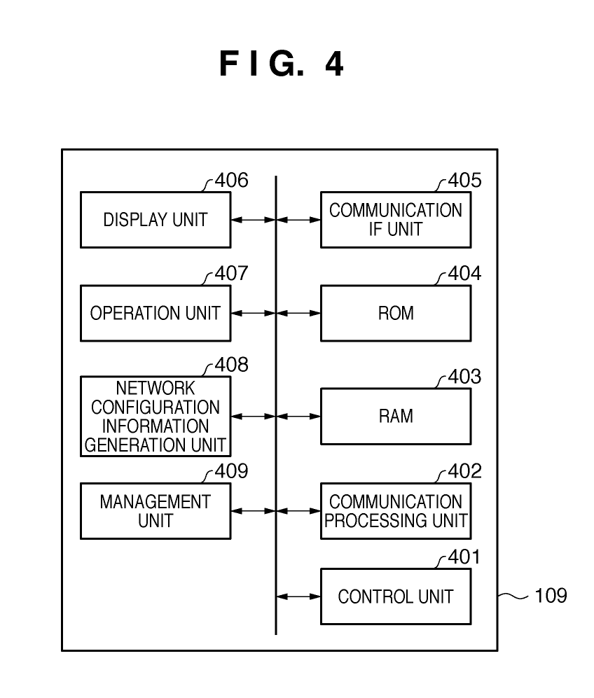

FIG. 4 is a diagram showing an exemplary internal configuration of the management device 109. A control unit 401 performs overall control of units included in the management device 109. A wired communication processing unit 402 performs control of communication via a communication IF unit 405. A RAM 403 is a volatile memory. A ROM 404 is a non-volatile memory storing control instructions (a computer program). The communication IF unit 405 is, for example, a wired LAN communication interface. A display unit 406 is a liquid crystal display or the like. An operation unit 407 is a switch, button, or the like. A network configuration information generation unit 408 generates network configuration information pertaining to the second network 106.

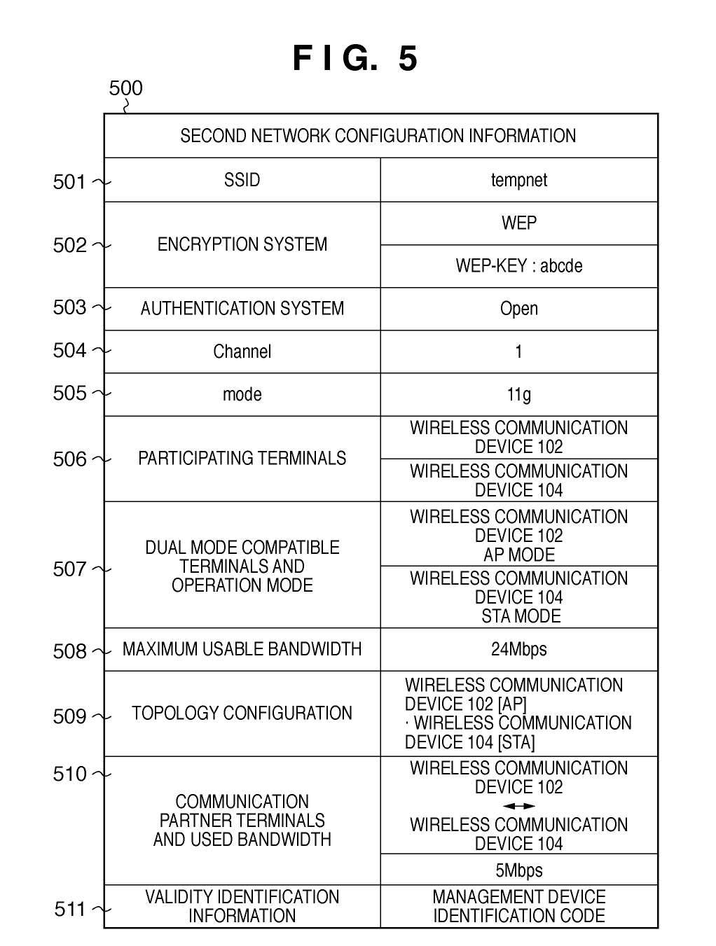

FIG. 5 is a diagram showing an example of network configuration information according to the present embodiment. Network configuration information 500 includes, for example, communication parameters, a topology configuration, a communication bandwidth, and authentication information expressing validity. The communication parameters include, for example, an SSID 501 of a wireless LAN, an encryption system 502, an authentication system 503, a wireless channel 504, a wireless LAN mode 505, participating terminals 506, and current operation mode of dual mode terminals 507.

The SSID 501 is identification information for identifying wireless networks. The encryption system 502 is the encryption system to be used in the wireless LAN, the encryption key for the encryption system, and the like. The authentication system 503 is the system used for authentication of the wireless LAN. The wireless channel 504 is, for example, the frequency used in wireless communication. The wireless LAN mode 505 indicates the standard to be used in wireless communication, and is 802.11a, 802.11b, 802.11g or the like. The participating terminals 506 is identification information for identifying wireless communication devices participating in the wireless network. The current operation mode of dual mode terminals 507 is identification information for identifying terminals that are dual mode compatible, and the operation mode (AP mode or STA mode) thereof.

A topology configuration 509 is information indicating which wireless communication device is operating as the access point, and which wireless communication devices are operating as terminals. The communication bandwidth is a maximum usable communication bandwidth 508, a communication partner terminal and used bandwidth 510, and the like. The communication partner terminal and used bandwidth 510 includes information pertaining to a communication partner terminal for each wireless link, the communication bandwidth allocated to the wireless links, and the like. Note that the used bandwidth means the communication bandwidth that is currently being used.

The authentication information is validity identification information 511 that indicates validity, and the like. The validity identification information 511 is, for example, an identification code of a management device or terminal.

A management unit 409 manages information regarding the networks being managed by the management device 109 and devices in the networks. The management unit 409 stores network configuration information or information necessary to generate network configuration information.

In FIG. 1, the access point 107 has created the first network 110. Also, the access point 107 is connected to the management device 109 via the wired LAN 108 that is an Ethernet (registered trademark) cable or the like. The wireless communication device 101 is connected to the access point 107, and can communicate with devices in the first network 110 and devices connected to the wired LAN 108.

The wireless communication device 102 is operating in the AP mode, as well as has created the second network 106. The wireless communication device 104 is operating in the STA mode and is participating in the second network 106. The wireless communication device 104 can perform direct communication with the wireless communication device 102.

In this case, although connected to the access point 107 at first, the wireless communication device 102 and wireless communication device 104 newly create the second network 106 that is separate from the first network 110, for reasons such as effective use of bandwidth.

The management device 109 manages information regarding the wireless networks and devices in the first network 110 (communication parameters, topology, communication bandwidth, and the like) via the wired LAN 108. The wireless communication device 102 and wireless communication device 104 were under the management of the management device 109 when they were connected to the access point 107. The network configuration information 500 pertaining to the second network 106 was transmitted to the management device 109 before the wireless communication device 102 and wireless communication device 104 created the second network 106. The management unit 409 of the management device 109 received the network configuration information 500 pertaining to the second network 106, and stored the received network configuration information 500 in the RAM 403.

In this case, the wireless communication device 101 that is participating in the first network 110 desires to participate in the second network 106 and communicate with the wireless communication device 104. The following describes a general representation of the invention according to the present embodiment with reference to a sequence diagram.

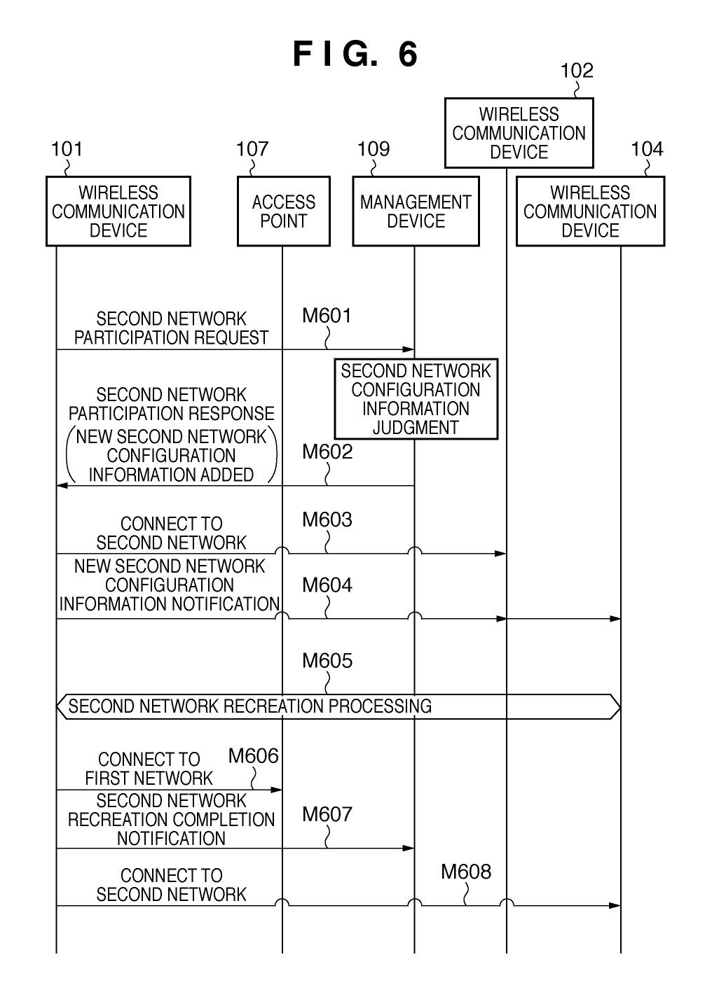

FIG. 6 is an exemplary sequence diagram showing a sequence in the communication method according to the present embodiment. The wireless communication device 101 transmits, to the management device 109 via the first network, a second network participation request message M601 that indicates a desire to participate in the second network 106. The second network participation request message M601 is an example of a connection request for connecting to the second network that is different from the first network.

The second network participation request message M601 includes identification information (MAC address, IP address, etc.) pertaining to the wireless communication device 104 that is the communication partner. Also, capability information pertaining to the wireless communication device 101 (information indicating, for example, whether a dual mode function is provided) and information indicating a communication bandwidth needed in a case of performing communication in the second network 106 may be added to the second network participation request message M601. Also, authentication information (validity identification information 511) for ensuring the validity of the message may be added to the second network participating request message M601. The authentication information may be a password or information encrypted with use of an authentication encryption key. In this way, the authentication information may be any information that enables the establishment of authentication with the management device.

Upon receiving the second network participation request message M601, the management device 109 determines, from among a plurality of topologies that can be formed when the wireless communication device 101 connects to the second network, the topology in which the communication bandwidth is relatively best. The management device 109 generates network configuration information indicating the determined topology. For example, the management device 109 specifies the communication partner based on the second network participation request message M601, specifies the network to which the specified communication partner belongs, and reads management data pertaining to the specified network from a RAM. The management data may be the currently active second network configuration information.

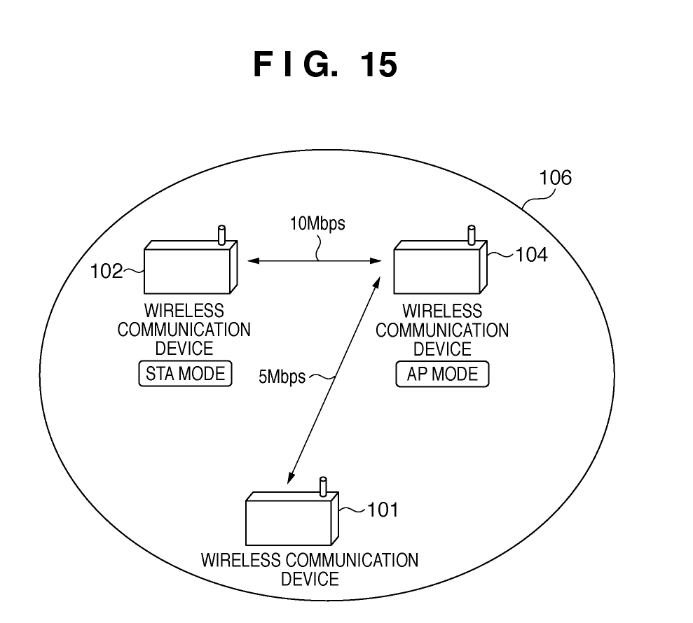

The management device 109 extracts capability information pertaining to terminals participating in the second network from the management data, and obtains information indicating whether dual mode terminals exist and in which operation mode the dual mode terminals are operating. The management device 109 also obtains information indicating the current topology configuration based on the management data. The management device 109 determines topologies for when each of the dual mode terminals among the terminals participating in the second network has been selected to be the access point, and determines which of these topologies would have the least amount of wasted communication bandwidth. For example, in the case of the present embodiment, the topology shown in FIG. 14 and the topology shown in FIG. 15 are determined. The total communication bandwidth in the example shown in FIG. 14 is calculated to be 25 Mbps, and the total communication bandwidth in the example shown in FIG. 15 is calculated to be 15 Mbps. Therefore, the management device 109 compares both of the communication bandwidths and judges that the network shown in FIG. 14 is relatively advantageous. The management device 109 therefore transmits, to the wireless communication device 101, a second network participation response message M602 including network configuration information that indicates the topology of FIG. 14.

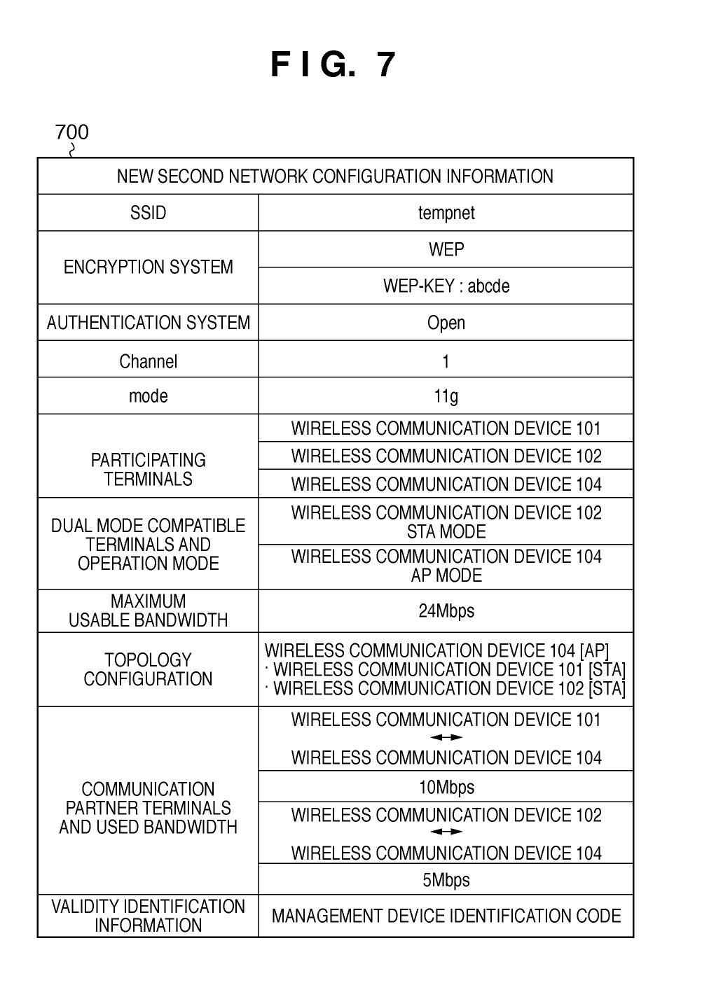

FIG. 7 is a diagram showing an example of newly generated network configuration information according to the present embodiment. Compared to the original second network configuration information 500, new second network configuration information 700 has been updated with information regarding the wireless communication device 101 that has newly participated. For example, the wireless communication device 101 has been added to the participating terminals 506. Also, the topology configuration 509 and used bandwidth 510 have been updated in accordance with the change in the topology.

Upon receiving the second network participation response message M602, the wireless communication device 101 disconnects the connection with the first network, and connects to the second network (M603).

The wireless communication device 101 generates a notification message M604 that includes network configuration information extracted from the second network participation response message M602, and transmits the notification message M604 to each wireless communication device participating in the second network.

Upon receiving the notification message M604, the wireless communication devices 102 and 104 recreate the second network in accordance with the network configuration information (M605). For example, the wireless communication device 104 switches from the STA mode to the AP mode in accordance with the network configuration information. Similarly, the wireless communication device 102 switches from the AP mode to the STA mode in accordance with the network configuration information. The wireless communication device 101 also performs recreation of the second network.

Upon completion of recreation of the second network, the wireless communication device 101 temporarily disconnects the connection with the second network, and connects to the first network (M606). Next, the wireless communication device 101 transmits, to the management device 109, a notification message M607 indicating that recreation of the second network has been completed. Accordingly, the management device 109 updates the management data regarding the second network. Lastly, the wireless communication device 101 disconnects the connection with the first network, and reconnects to the second network (M608).

The following describes communication processing performed by each wireless communication device with reference to flowcharts.

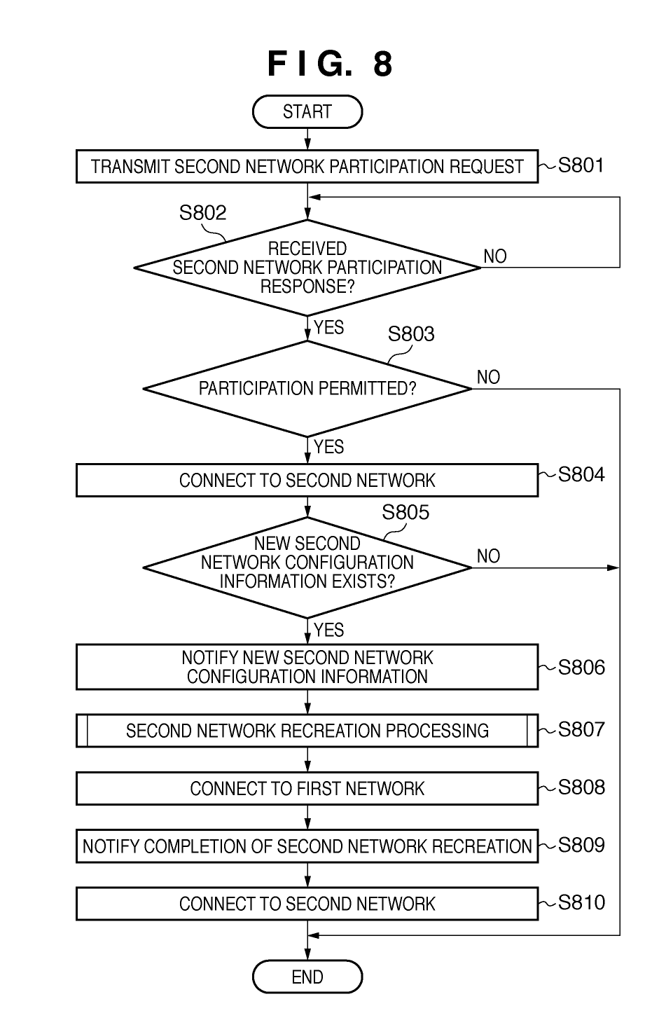

FIG. 8 is a flowchart showing an example of communication processing performed by the wireless communication device 101 according to the present embodiment. The wireless communication device 101 is participating in the first network at first.

In step S801, the control unit 201 of the wireless communication device 101 creates the second network participation request message M601, and transmits the message M601 to the management device 109 via the wireless communication processing unit 202, antenna control unit 206 and antenna 205. The second network participation request message M601 includes the identification information pertaining to the wireless communication device 104 that is the communication partner, the capability information pertaining to the wireless communication device 101, information indicating the necessary communication bandwidth, and authentication information. Although authentication information is used in the present embodiment, the authentication information and authentication processing may be omitted. Note that the control unit 201, wireless communication processing unit 202, etc. of the wireless communication device 101 are examples of a first transmission means for transmitting, to the management device, a connection request for connecting to the second network that is different from the first network. Also, the control unit 201 is an example of an inclusion means for including, in the connection request, authentication information indicating the validity of a first terminal and the connection request.

In step S802, the control unit 201 waits for reception of the second network participation response message M602 from the management device 109. The second network participation response message M602 is received by the antenna 205, antenna control unit 206, wireless communication processing unit 202, and control unit 201. The control unit 201, wireless communication processing unit 202, etc. are examples of a first reception means for receiving network configuration information indicating the topology determined by the management device 109. In other words, the first reception means receives, from the management device, network configuration information indicating a predetermined topology from among a plurality of topologies that can be formed when the first terminal connects to the second network.

In step S803, the control unit 201 judges whether participation in the second network 106 is possible, based on the received second network participation response message M602. The message M602 includes information indicating whether participation is possible and network configuration information. If participation is possible, processing proceeds to step S804. On the other hand, if participation is not possible, processing for participating in the second network is stopped.

In step S804, the control unit 201 controls the wireless communication processing unit 202 to connect to the second network 106.

In step S805, the control unit 201 judges whether new second network configuration information has been added to the received second network participation response message M602. The addition of new second network configuration information means that recreation of the network is necessary, and the lack of new second network configuration information means that recreation is not necessary. If the new second network configuration information has been added, processing proceeds to step S806. If the new second network configuration has not been added, the control unit 201 ends the processing shown in the flowchart of FIG. 8.

In step S806, the control unit 201 transmits the notification message M604 including the new second network configuration information to each communication device belonging to the second network 106 (wireless communication device 102 and wireless communication device 104). The control unit 201, etc., is an example of a notification means for notifying network configuration information to a plurality of terminals participating in the second network. This enables causing the received network configuration information to be reflected in the terminals participating in the second network.

Note that information for ensuring the validity of the new second network configuration information 700 may be added to the new second network configuration information 700. Such information may be a password or an identification code of the management device 109. Of course, other information may be used, as long as such information can ensure the validity of the new second network configuration information 700. The control unit 201 etc. is an example of a third transmission means for transmitting authentication information indicating a validity of the first terminal to the second network along with network configuration information. Note that processing for authenticating the validity of the new second network configuration information 700 may be omitted.

In step S807, the control unit 201 recreates the second network in accordance with the new second network configuration information 700. For example, the control unit 201 receives a beacon from the wireless communication device 104 that has newly started operating in the AP mode, and transmits a participation request to the wireless communication device 104. Upon detecting that recreation of the second network has been completed, the control unit 201 proceeds to step S808. In this way, the control unit 201, etc., is an example of a recreation means for recreating the second network along with the plurality of terminals participating in the second network, in accordance with the network configuration information. Also, the control unit 201 is an example of a confirmation means for confirming whether recreation of the second network has been completed.

In step S808, the control unit 201 disconnects the connection with the second network, and reconnects to the first network. The control unit 201 is an example of a disconnection means for disconnecting the connection to the second network upon completion of recreation of the second network. Also, the control unit 201 is an example of a connection means for connecting to the first network upon disconnection of the connection with the second network.

In step S809, the control unit 201 transmits the notification message M607 indicating that recreation of the second network has been completed to the management device 109 via the first network. The control unit 201 is an example of a fourth transmission means for transmitting a message indicating that recreation of the second network has been completed to the management device via the first network.

Here, the notification message M607 may be transmitted by the wireless communication device 102 or wireless communication device 104 instead of the wireless communication device 101. Also, the management device 109 may detect that recreation of the second network has been completed. For example, due to having created the new second network configuration information 700, the management device 109 is informed of which wireless communication device is operating in the AP mode. Therefore, if a beacon can be received from the wireless communication device 104, the completion of recreation of the second network can be detected.

In step S810, the control unit 201 disconnects the connection with the first network, and reconnects to the second network. The control unit 201 is an example of a reconnection means for disconnecting the connection with the first network and reconnecting to the second network.

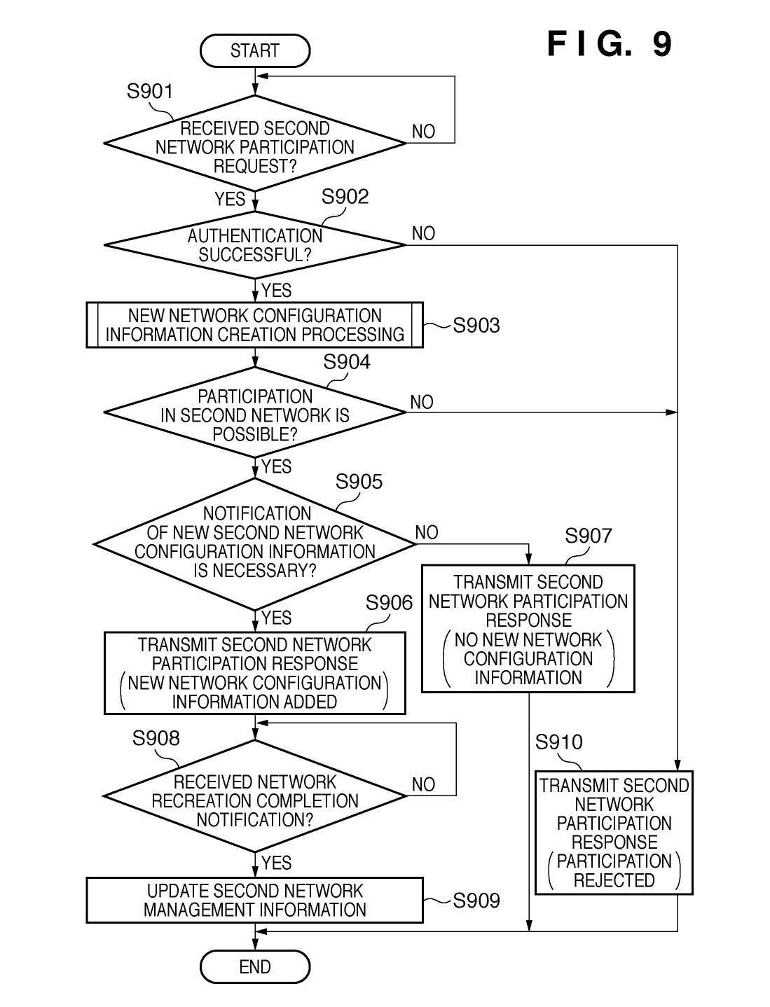

FIG. 9 is a flowchart showing an example of communication processing performed by the management device 109 according to the present embodiment.

In step S901, the control unit 401 of the management device 109 waits for reception of the second network participation request message M601. Upon reception of the second network participation request message M601, processing proceeds to step S902. The control unit 401 etc. is an example of a second reception means for receiving a connection request for connecting to the second network from the first terminal.

In step S902, the control unit 401 performs authentication processing for checking the validity of the received message, and judges whether the authentication is successful. The authentication processing is performed by, for example, comparing the authentication information included in the second network participation request message M601 and authentication information stored in the ROM 404 or RAM 403 in advance. If the authentication fails, processing proceeds to step S910. In step S910, the control unit 401 generates the second network participation response message M602 indicating that the wireless communication device 101 cannot participate in the second network, and transmits the message M602 to the wireless communication device 101. On the other hand, if the authentication is successful, processing proceeds to step S903. In this way, the control unit 401 is an example of a first authentication means for performing authentication processing with use of authentication information obtained from a connection request, in order to judge whether to permit the first terminal to participate in the second network.

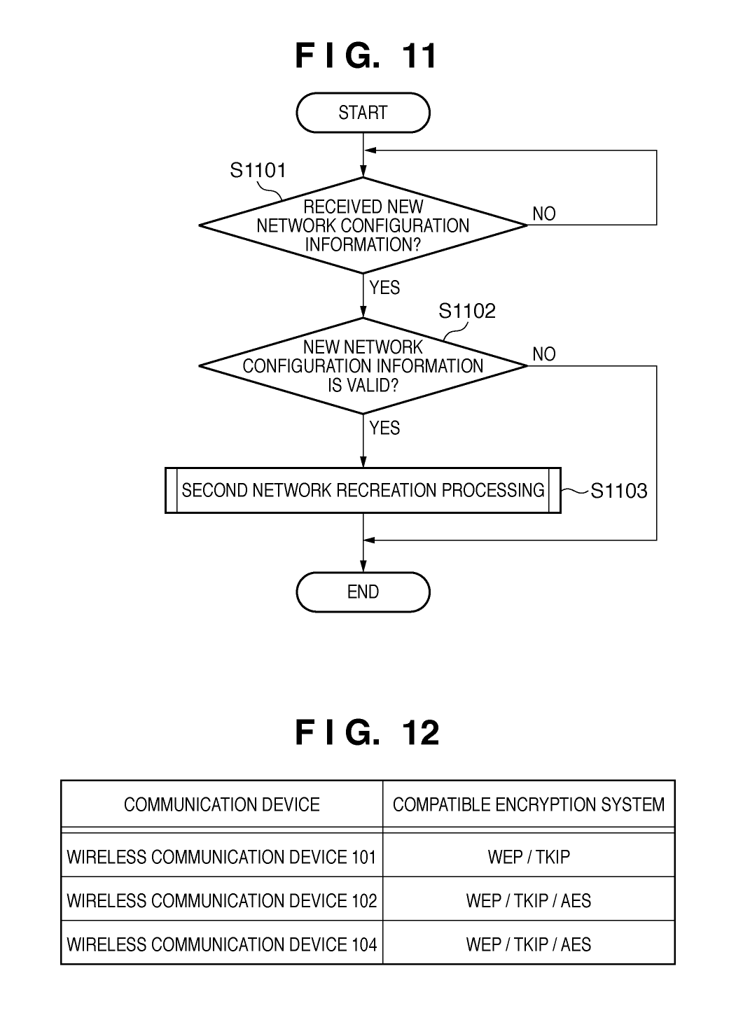

In step S903, the control unit 401 instructs the management unit 409 to perform processing for creating the new second network configuration information. The management unit 409 furthermore instructs the network configuration information generation unit 408 to generate the new second network configuration information. Details of this processing are described later with reference to FIG. 11.

In step S904, the control unit 401 judges whether the wireless communication device 101 can participate in the second network, based on a result of the judgment performed in the network configuration information creation processing. In a case of judging that the wireless communication device 101 cannot participate in the second network, processing proceeds to step S910. In step S910, the control unit 401 transmits, to the wireless communication device 101, the second network participation response message M602 indicating that the wireless communication device 101 cannot participate in the second network. On the other hand, in a case of judging that the wireless communication device 101 can participate in the second network, processing proceeds to step S905.

In step S905, the control unit 401 judges whether it is necessary to notify new second network configuration information to wireless communication devices that are participating in the second network 106. For example, if the management unit 409 created new second network configuration information in step S903, the topology has changed, and therefore the control unit 401 judges that notification is necessary. If notification of new second network configuration information is not necessary (if the current topology is sufficient), processing proceeds to step S907. In step S907, the control unit 401 transmits, to the wireless communication device 101, the second network participation response message M602 to which new second network configuration information has not been added. If notification of new second network configuration information is necessary, processing proceeds to step S906.

In step S906, the control unit 401 transmits, to the wireless communication device 101, the second network participation response message M602 to which the new second network configuration information 700 created by the management unit 409 has been added. The new second network configuration information 700 includes, for example, information indicating the new topology and information designating the operation mode of the wireless communication device 102 and wireless communication device 104. The control unit 401, etc., is an example of a second transmission means for transmitting the generated network configuration information to the first terminal. In other words, the second transmission means transmits, to the first terminal, network configuration information indicating a predetermined topology from among a plurality of topologies that can be formed when the first terminal connects to the second network.

In step S908, the control unit 401 waits for reception of the notification message M607 indicating that recreation of the second network has been completed. Upon reception of the notification message M607, processing proceeds to step S909.

In step S909, the management unit 409 updates the management data regarding the second network with use of the new second network configuration information.

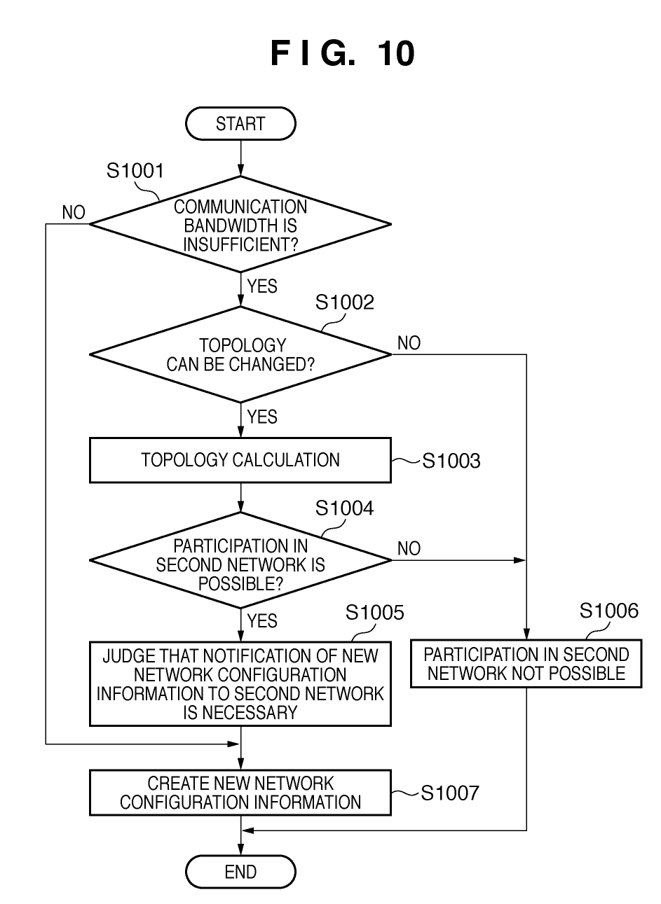

FIG. 10 is a flowchart showing an example of new second network configuration information creation processing (S903) according to the present embodiment. Although described below as being performed by the management unit 409, the new second network configuration information creation processing may be performed by the control unit 401.

In step S1001, the network configuration information generation unit 408 judges whether the communication bandwidth in the second network 106 would be sufficient if the wireless communication device 101 participated in the second network 106 while maintaining the current topology of the second network 106. This judgment processing is synonymous with judging whether recreation of the second network is necessary in a case of the wireless communication device 101 participating in the second network.

For example, information indicating the communication bandwidth needed by the wireless communication device 101 in the second network 106 has been added to the second network participation request message M601. In this case, the management unit 409 judges whether a sum of current communication bandwidth information and the communication bandwidth information required by the wireless communication device 101 exceeds information indicating the maximum communication bandwidth that can be realized in the second network 106. If the judgment is affirmative, the control unit 401 proceeds to step S1002 in order to try changing the topology. However, if the communication bandwidth that can be realized is sufficient, processing proceeds to step S1007. In step S1007, the network configuration information generation unit 408 creates the new second network configuration information 700 in which the participating terminals, topology configuration, communication partner terminals, and used bandwidth have been updated. In other words, the network configuration information generation unit 408 generates a message that permits connection to the second network while maintaining the current topology.

In step S1002, the network configuration information generation unit 408 judges whether the network work topology of the second network can be changed. For example, the network configuration information generation unit 408 reads the second network configuration information 500 from the RAM 403, and judges whether any dual mode terminals other than the wireless communication device operating as the current access point exist. Alternatively, the network configuration information generation unit 408 may judge whether any additional dual mode terminals exist, including the wireless communication device operating as the current access point. The network configuration information generation unit 408 is an example of a judgment means for judging whether a plurality of terminals that can operate as the access point exist in the second network.

According to FIG. 5, the network configuration information generation unit 408 detects that the wireless communication device 102 is the current access point, and a dual mode terminal (i.e., the wireless communication device 104) exists. If a dual mode terminal other than the wireless communication device operating as the current access point exists, the topology can be changed, and therefore processing proceeds to step S1003. However, if a dual mode terminal other than the wireless communication device operating as the current access point does not exist, the topology cannot be changed, and therefore processing proceeds to step S1006. In step S1006, the network configuration information generation unit 408 determines that the wireless communication device 101 cannot participate in the second network 106.

In step S1003, the network configuration information generation unit 408 performs topology calculation. For example, the network configuration information generation unit 408 calculates the communication bandwidth of each topology formed when dual mode terminals participating in the second network are caused to operate in the AP mode. Furthermore, the network configuration information generation unit 408 selects the topology having the lowest communication bandwidth from among the calculated communication bandwidths of the topologies. For example, the communication bandwidth of the topology shown in FIG. 14 is calculated to be 25 Mbps, and the communication bandwidth of the topology shown in FIG. 15 is calculated to be 15 Mbps. For example, the network configuration information generation unit 408 selects the topology shown in FIG. 15, which has the lowest communication bandwidth. In this way, the network configuration information generation unit 408 is an example of a calculation means for calculating the communication bandwidth of a topology formed when the terminal operating as the access point has been switched to another terminal. This is based on the assumption of a case in which a plurality of terminals that can operate as the access point exists in the second network. Also, the network configuration information generation unit 408 is an example of a specification means for specifying a best communication bandwidth from among the calculated communication bandwidths and the communication bandwidth of the current topology. Note that the specification means is also a determination means for determining a predetermined topology in accordance with the calculated communication bandwidths and the communication bandwidth of the current topology.

The second transmission unit transmits the network configuration information indicating the topology determined by the determination means to the first terminal. A case of transmitting the communication bandwidth of the current topology means that the wireless communication device 101 can participate in the second network without switching the access point.

In step S1004, the network configuration information generation unit 408 judges whether each calculated communication bandwidth is less than or equal to the maximum usable bandwidth in the current network configuration information 500. If a calculated communication bandwidth is less than or equal to the maximum usable bandwidth, the wireless communication device 101 can participate in the second network. In this case, processing proceeds to step S1005. However, if none of the calculated communication bandwidths is less than or equal to the maximum usable bandwidth, the wireless communication device 101 cannot participate in the second network, and therefore processing proceeds to step S1006.

Since a topology change is necessary in the second network 106, in step S1005 the network configuration information generation unit 408 judges that it is necessary to notify a topology change to the wireless communication device 102 and wireless communication device 104 in the second network 106.

In step S1007, the network configuration information generation unit 408 creates the new second network configuration information 700 for realizing the topology having the lowest communication bandwidth. In this way, the network configuration information generation unit 408 is an example of a determination means for determining the topology having the relatively best communication bandwidth among a plurality of topologies that can be formed when the first terminal is connected to the second network. Also, the network configuration information generation unit 408 is an example of a generation means for generating network configuration information indicating the determined topology.

According to FIG. 10, if a plurality of terminals than can operate as the access point exist in the second network, network configuration information indicating the topology having the best communication bandwidth is generated (S1007). Also, if a plurality of terminals that can operate as the access point do not exist in the second network, a message rejecting the connection to the second network is generated (S1004:NO, proceed to S1006). Also, a message permitting the connection to the second network while maintaining the current topology is generated (S1001:NO, proceed to S1007).

FIG. 11 is an exemplary flowchart showing communication processing performed by the wireless communication device 102 and wireless communication device 104 according to the present embodiment.

In step S1101, the control unit 301 waits for reception of the notification message M604 for notifying the new second network configuration information. Upon reception of the notification message M604, processing proceeds to step S1102.

In step S1102, the control unit 301 judges whether the received message is valid. The judgment of validity is performed with use of the above-described authentication information (validity identification information). If the received message is not valid, the processing in the flowchart of FIG. 11 ends without network recreation being performed. However, if the control unit 301 judges that the new second network configuration information is valid, processing proceeds to step S1103. In this way, the control unit 301 is an example of a second authentication means for performing authentication processing with use of authentication information, in order to judge whether the second network is to be recreated with use of the network configuration information received from the first terminal.

In step S1103, the control unit 301 performs processing for recreating the second network in accordance with the new second network configuration information. For example, the operation mode of the wireless communication device 102 is changed from the AP mode to the STA mode. In other words, the STA mode operation unit 312 starts operating in accordance with an instruction from the control unit 301. On the other hand, the operation mode of the wireless communication device 104 is changed from the STA mode to the AP mode. In other words, the AP mode operation unit 311 starts operating in accordance with an instruction from the control unit 301.

According to the present embodiment, the topology having the relatively best communication bandwidth is selected from among a plurality of topologies that can be formed when a certain terminal connects to the second network. This enables recreating the second network so that communication bandwidth is not wasted when the certain terminal participates in the second network.

Also, the topology having the relatively best communication bandwidth is selected by comparing the communication bandwidths of topologies that are formed when the terminal operating as the access point in the second network is switched to another terminal. In other words, the topology can be changed if a plurality of dual mode terminals exist, and therefore it is possible that the best topology for when the certain terminal newly participates is different from the current topology. Accordingly, calculating each communication bandwidth for a plurality of potentially formable topologies facilitates determining a better topology. Of course, there is no need to change the topology or access point if the current topology is the best.

Furthermore, including authentication information indicating the validity of the participation requesting terminal in the participation request enables lowering the possibility of an unauthorized terminal participating in the second network. This also suppresses a change in topology and reduction in communication bandwidth due to an unauthorized terminal participating in the second network.

Also, a change in topology according to unauthorized network configuration information can be suppressed since the participation requesting terminal transmits authentication information indicating the validity of the network configuration information to the second network along with the network configuration information.

Also, the management device can constantly keep the network configuration information of the second network updated since the management device is notified that recreation of the second network has been completed.

### Embodiment 2

In Embodiment 1, processing for newly creating network configuration information is performed with use of mainly topology information and communication bandwidths. The present embodiment describes processing for newly creating network configuration with use of communication parameters.

FIG. 12 is a diagram showing a list of encryption systems with which wireless communication devices according to the present embodiment are compatible. This list is held in, for example, a RAM of the management device 109. According to this list, the wireless communication device 101 is compatible with WEP and TKIP. The wireless communication devices 102 and 104 are compatible with WEP, TKIP and AES. In general, AES has the highest level of encryption, and WEP has the lowest level of encryption. Accordingly, among the encryption systems shared by all three of the wireless communication devices, TKIP is the encryption system having the highest level of encryption.

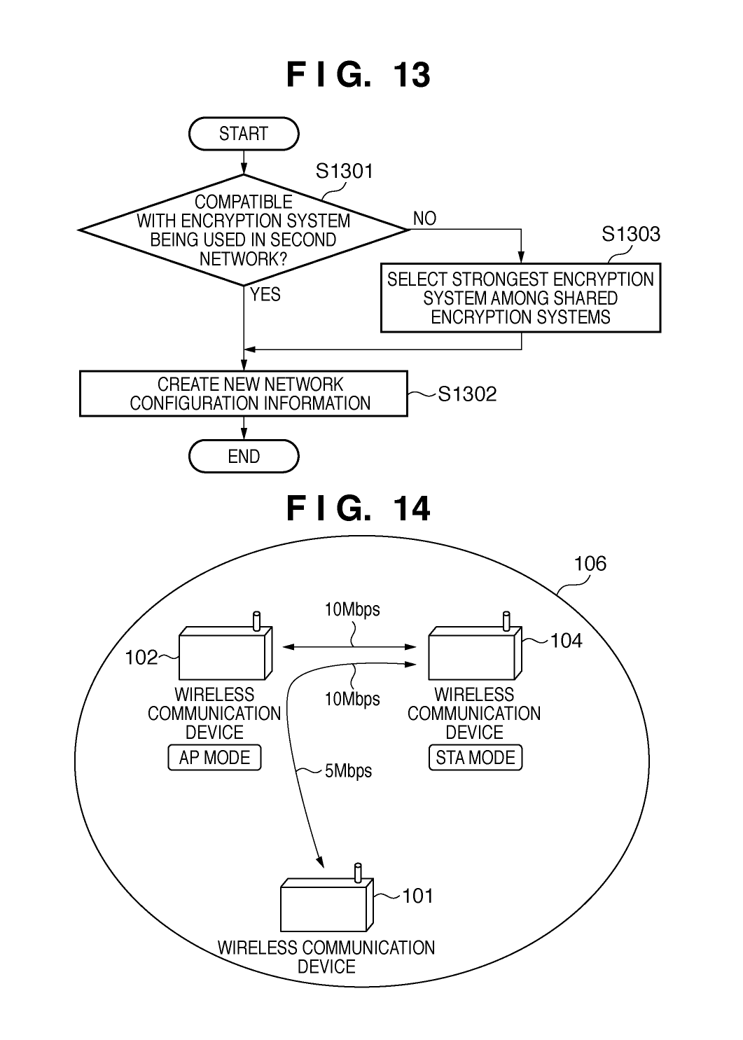

FIG. 13 is a flowchart showing an example of processing for newly creating network configuration information based on an encryption system (5903).

In step S1301, the network configuration information generation unit 408 judges whether the wireless communication device 101 is compatible with the encryption system currently being used in the second network 106. The network configuration information generation unit 408 can become informed of the encryption systems that the wireless communication device 101 is compatible with by referencing the list shown in FIG. 12. Also, the network configuration information generation unit 408 can become informed of the encryption system currently being used in the second network 106 by reading the management data (network configuration information 500) from the RAM.

If the wireless communication device 101 is compatible with the encryption system currently being used, processing proceeds to step S1302. In step S1302, the network configuration information generation unit 408 generates the new second network configuration information 700 that reflects a topology in which the wireless communication device 101 has been added.

However, if the wireless communication device 101 is not compatible with the encryption system currently being used, processing proceeds to step S1303. In step S1303, the network configuration information generation unit 408 selects, from among the encryption systems shared by all three of the wireless communication devices, the encryption system that has the highest level of encryption. In step S1302, the network configuration information generation unit 408 generates the new second network configuration information 700 that reflects the selected encryption system and a topology in which the wireless communication device 101 has been added.

According to the present embodiment, information pertaining to encryption systems can be employed as a communication parameter included in the network configuration information. Also, the network configuration information generation unit 408 functions as a selection means for comparing a communication parameter with which the first terminal is compatible and a communication parameter with which the terminals participating in the second network are compatible, and selecting the communication parameter that has the highest level of security. In other words, the management device determines a communication parameter for a case of recreating the second network, based on security information pertaining to the first terminal and security information pertaining to the terminals participating in the second network.

For example, consider a case of AES being used in the second network, and the wireless communication device 101 requesting to participate in the second network 106. In this case, TKIP is selected since the wireless communication device 101 is not compatible with AES. Accordingly, the networking configuration information generation unit 408 generates the new second network configuration information 700 in which the wireless LAN encryption system of the second network 106 has been changed to TKIP.

Upon receiving the new second network configuration information 700, the wireless communication device 101 transfers the new second network configuration information 700 to each wireless communication device in the second network 106. Accordingly, the encryption system in the second network 106 is changed to TKIP. Note that the new second network configuration information may be notified as a control message. Also, an encryption system and encryption key for control may be shared and held by each of the wireless communication devices, and the new second network configuration information may be notified with use of such encryption key and encryption system.

It should also be mentioned that there are cases in which lowering the level of encryption in the second network is undesirable. In such cases, a policy designating a weakest permissible encryption system is stored in a RAM or ROM of the management device 109 in advance. If the wireless communication device 101 is not compatible with the weakest encryption system designated by the policy, the management unit 409 can reject participation in the second network 106 by the wireless communication device 101.

According to the present embodiment, even if a certain terminal newly participates in the second network, the communication parameter having the highest level of security is selected. This facilitates maintaining secure communication even if the topology has changed.

### Other Embodiments

Processing for newly creating network configuration information is performed using topologies and communication bandwidths in Embodiment 1 and using encryption systems in Embodiment 2. Here, Embodiments 1 and 2 may be combined. In this case, the processing shown in FIG. 10 and the processing shown in FIG. 13 are performed, and the wireless communication device 101 cannot participate if participation is judged to not be possible in either of the processing. Also, if participation is judged to be possible, the topology etc. determined in the processing shown in FIG. 10 and the encryption system determined in the processing shown in FIG. 13 are reflected in new network configuration information.

Although the management device 109 is connected to the wired LAN 108, the present invention is not limited to this. For example, the management device 109 may include a wireless LAN function and be connected to the access point 107.

The functionality of the management device 109 may be provided in the access point 107. In this case, the management device 109 is unnecessary. In other words, it is only necessary for a device including the functionality of the management device 109 to exist in the first network 110.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-063160, filed Mar. 12, 2008, which is hereby incorporated by reference herein in its entirety.

1. A communication system including a plurality of terminals and a management device that manages a plurality of networks,
the plurality of terminals including a first terminal that is connected to a first network to which the management device is connected, the first terminal comprising:
a first transmission unit which transmits, to the management device, a connection request for connecting to a second network that is different from the first network;
a first reception unit which receives from the management device, network configuration information indicating a predetermined topology from among a plurality of topologies that can be formed when the first terminal connects to the second network;
a notification unit which notifies the received network configuration information to a plurality of terminals participating in the second network; and
a recreation unit which recreates the second network along with the plurality of terminals participating in the second network, in accordance with the network configuration information, and
the management device comprising:
a second reception unit which receives the connection request from the first terminal; and
a second transmission unit which transmits, to the first terminal, the network configuration information indicating the predetermined topology from among the plurality of topologies that can be formed when the first terminal connects to the second network.

2. The communication system of claim 1,
wherein the management device further comprises:
a judgment unit which judges whether a plurality of terminals that can operate as an access point exist in the second network;
a calculation unit which, if the plurality of terminals that can operate as the access point exist in the second network, calculates a communication bandwidth of a topology formed when a terminal operating as the access point is switched to another terminal; and
a determination unit which determines the predetermined topology in accordance with the calculated communication bandwidth and a communication bandwidth of a current topology, and
wherein the second transmission unit transmits the network configuration information indicating the topology determined by the determination unit to the first terminal.

3. The communication system of claim 1,
wherein if a plurality of terminals that can operate as an access point do not exist in the second network, the management device rejects connection to the second network by the first terminal, or permits connection to the second network by the first terminal while maintaining a current topology.

4. The communication system of claim 1,
wherein the management device determines a parameter in a case of recreating the second network, in accordance with security information pertaining to the first terminal and security information pertaining to the plurality of terminals participating in the second network.

5. The communication system of claim 1,
wherein the connection request includes authentication information indicating a validity of the first terminal, and
the management device performs authentication processing with use of the authentication information obtained from the connection request, in order to judge whether to permit the first terminal to participate in the second network.

6. The communication system of claim 1,
wherein the first terminal transmits authentication information indicating a validity of the network configuration information to the second network along with the network configuration information, and
another terminal participating in the second network performs authentication processing with use of the authentication information, in order to judge whether to recreate the second network with use of the network configuration information received from the first terminal.

7. The communication system of claim 1,
wherein the first terminal further comprises:
a confirmation unit which confirms whether recreation of the second network has been completed;
a connection unit which connects to the first network upon completion of recreation of the second network; and
a third transmission unit which transmits, to the management device via the first network, a message indicating that recreation of the second network has been completed.

8. A communication method in a communication system including a plurality of terminals and a management device that manages a plurality of networks, comprising the steps of:
transmitting to the management device, by a first terminal that is included in the plurality of terminals and is connected to a first network to which the management device is connected, a connection request for connecting to a second network that is different from the first network;
receiving from the first terminal, by the management device, the connection request for connecting to the second network;
transmitting to the first terminal, by the management device, network configuration information indicating a predetermined topology from among a plurality of topologies that can be formed when the first terminal connects to the second network;
receiving the network configuration information by the first terminal;
notifying, by the first terminal, the received network configuration information to a plurality of terminals participating in the second network; and
recreating, by the first terminal, the second network along with the plurality of terminals participating in the second network, in accordance with the network configuration information.

9. A terminal in a communication system including a management device that manages a plurality of networks, the terminal comprising:
a first transmission unit which transmits, to the management device, a connection request for connecting to a second network that is different from a first network to which the management device is connected;
a reception unit which receives, from the management device, network configuration information indicating a predetermined topology from among a plurality of topologies that can be formed when the terminal connects to the second network;
a notification unit which notifies the received network configuration information to a plurality of terminals participating in the second network; and
a recreation unit which recreates the second network along with the plurality of terminals participating in the second network, in accordance with the network configuration information.

10. A management device that manages a plurality of networks, comprising:
a reception unit which receives a connection request from a first terminal that is connected to a first network to which the management device is also connected, the connection request being for connecting to a second network that is different from the first network; and
a transmission unit which transmits, to the first terminal, network configuration information indicating a predetermined topology from among a plurality of topologies that can be formed when the first terminal connects to the second network.
